(19) United States
(12) Patent Application Publication
(10) Pub. No.: US 2026/0210766 A1
(43) Pub. Date: Jul. 23, 2026

(54) HANDHELD THERMAL IMAGER

(71) Applicant: VISIR INC., Richardson, TX (US)

(72) Inventors: Zhangjun HOU, Richardson, TX (US); Yichen SUN, Richardson, TX (US); Xiaoyu LIU, Richardson, TX (US)

(21) Appl. No.: 19/456,026

(22) Filed: Jan. 22, 2026

(30) Foreign Application Priority Data
Jan. 22, 2025 (CN) 202520150051.6
Jan. 22, 2025 (CN) 202520150052.0

(51) Int. Cl. G01J 5/02; G01J 5/00; G01J 5/08; G01J 5/0806

(52) U.S. Cl. CPC G01J 5/022; G01J 5/0205; G01J 5/026; G01J 5/0806; G01J 5/0843; G01J 5/0884; G01J 2005/0077

(57) ABSTRACT

A handheld thermal imager includes an objective lens assembly, a body assembly, and an eyepiece assembly that are arranged in sequence. The body assembly is provided with a focusing mechanism and a control mechanism. The focusing mechanism includes a focusing knob located at one end of the body assembly close to the eyepiece assembly. The focusing knob is partially exposed from an upper wall of a housing of the body assembly to be turned by a holding hand for focusing. The control mechanism comprises buttons arranged on the upper wall of the housing to be pressed by fingers of the holding hand. Both focusing and button operation can be performed by the holding hand, without requiring the involvement of the other hand.

### CROSS REFERENCE TO RELATED APPLICATIONS

The present invention claims priority under 35 U.S.C. § 119 to Chinese patent application No. 202520150052.0, titled “HANDHELD THERMAL IMAGER WITH ONE-HAND FOCUSING”, filed on Jan. 22, 2025 with the China National Intellectual Property Administration and Chinese patent application No. 202520150051.6, titled “ONE-HAND FOCUSING DEVICE AND HANDHELD THERMAL IMAGER”, filed on Jan. 22, 2025 with the China National Intellectual Property Administration, which are incorporated in the present application by reference in their entireties.

### FIELD

The present application relates to the technical field of imaging apparatuses, and in particular to a handheld thermal imager.

### BACKGROUND

A handheld observing and aiming apparatus generally includes three main body components: a front lens, a middle body, and a rear eyepiece, supplemented by accessories such as a lens cover, a photoelectric sensing assembly, a power supply assembly, and an eyecup. A focusing knob converts rotation into extension and retraction of the lens via mechanical transmission to perform focus adjustment for clear imaging.

In conventional imaging apparatuses, a focusing mechanism for the lens is generally arranged near a lens optical mechanism, and a diopter adjustment knob for the eyepiece is generally arranged near an eyepiece optical mechanism. Frequent lens focus adjustment is required for a user observing targets at varying distances, requiring one hand to hold the apparatus while the other hand to operate both buttons and the focusing mechanism for the lens, occupying both hands, which is highly inconvenient.

For those skilled in the art, a technical issue to be addressed currently is how to perform focusing and button operations with one hand.

### SUMMARY

The core of the present application is to provide a handheld thermal imager with one-hand focusing, which allows focusing and button operations to be performed with fingers of the holding hand, thereby improving convenience of use. Following solutions are provided according to the present application.

A handheld thermal imager includes an objective lens assembly, a body assembly, and an eyepiece assembly that are arranged in sequence. The body assembly is provided with a focusing mechanism and a control mechanism. The focusing mechanism includes a focusing knob located at one end of the body assembly close to the eyepiece assembly. The focusing knob is partially exposed from an upper wall of a housing of the body assembly to be turned by a holding hand for focusing. The control mechanism includes buttons arranged on the upper wall of the housing to be pressed by fingers of the holding hand.

Optionally, the buttons are arranged in at least one row in an optical-axis direction, with at least one button provided in each row in a direction perpendicular to the optical-axis direction.

Optionally, there are at least four buttons distributed at four vertexes of a rhombus.

Optionally, the control mechanism further includes a circuit board on which the buttons are arranged, the circuit board is fixed inside the housing.

Optionally, the focusing mechanism further includes a transmission shaft and a focusing seat. The focusing knob is connected to the transmission shaft in such a manner that they are fixed relative to each other in a circumferential direction. The focusing seat is movably connected at one end to the transmission shaft, and is connected at the other end to a core mechanism inside the housing. The transmission shaft is configured to, when rotated by the focusing knob, drive the focusing seat and thus the core mechanism to translate in the optical-axis direction.

Optionally, a helical groove is formed in a side wall of the transmission shaft, and the focusing seat is provided with a guide pin. The guide pin is slidably inserted into the helical groove to move helically relative to the helical groove.

Optionally, the helical groove is configured as a non-enclosed groove with unconnected ends, or an enclosed groove with connected ends.

Optionally, a main bracket is arranged inside the housing. The focusing mechanism further includes a transmission strip connected between the focusing seat and the core mechanism. A supporting seat is arranged on the main bracket, and a guide slot is formed in a side wall of the supporting seat. An avoidance channel is formed in the transmission strip, and at least part of an edge of the avoidance channel is slidably inserted into the guide slot.

Optionally, a core bracket of the core mechanism is configured to translate relative to an objective lens bracket of the objective lens assembly in the optical-axis direction, and is fixed relative to the objective lens bracket of the objective lens assembly in the circumferential direction. A side block is arranged between a sidewall of the core bracket and a corresponding sidewall of the objective lens bracket. A first sliding block is arranged between a top wall of the core bracket and a top wall of the objective lens bracket, and a second sliding block is arranged between the top wall of the objective lens bracket and the transmission strip.

Optionally, a mounting boss extends from the top wall of the core bracket to be screwed with a screw so as to secure the first sliding block, the second sliding block, and the transmission strip. An avoidance notch is formed in the top wall of the objective lens bracket to avoid the mounting boss.

Optionally, a supporting stud extends upward from an upper part of the main bracket to support the circuit board. an avoidance hole is formed in the transmission strip to avoid the supporting stud.

Optionally, a position-limiting plate is arranged on the main bracket to engage with an annular groove formed in the transmission shaft.

Optionally, the eyepiece assembly includes a diopter adjustment knob. The diopter adjustment knob is rotatable about an optical axis for diopter adjustment.

Optionally, the focusing knob is configured to rotate about a rotating axis parallel to the optical axis.

Optionally, the focusing knob is positioned to such that, when the handheld thermal imager is held by a user for operation, the focusing knob is accessible to an index finger of the holding hand, and the buttons are accessible to a middle finger, a ring finger, and a little finger of the holding hand, respectively.

Optionally, the buttons are positioned in the optical-axis direction between the objective lens assembly and the focusing knob, and the buttons as a whole are positioned closer to the focusing knob than to the objective lens assembly.

Optionally, the circuit board is fixed inside the housing, and the circuit board is provided with a printed circuit for transmitting pressing signals.

Optionally, the focusing seat is mounted on the main bracket and slidable in the optical-axis direction.

Optionally, the core bracket of the core mechanism and the objective lens bracket of the objective lens assembly each are a rectangular frame.

Optionally, the core bracket, the first sliding block, the second sliding block, and the transmission strip are fixedly connected together.

In the handheld thermal imager with one-hand focusing according to the present application, the body assembly is provided with the focusing mechanism and the control mechanism, the focusing mechanism includes the focusing knob located at one end of the body assembly close to the eyepiece assembly, the focusing knob is partially exposed from an upper part of the body assembly and is accessible to the index finger of the holding hand to be turned, thereby driving the core mechanism inside the body assembly to translate along the optical axis to achieve focusing. The focusing process is performed by fingers of the holding hand without requiring involvement of the other hand, thereby achieving the one-hand focusing. The control mechanism is provided with several buttons arranged on the upper part in a middle area of the body assembly in the optical-axis direction, accessible to the index finger, the middle finger, the ring finger, and the little finger of the holding hand to be pressed, thereby enabling one-hand button operation. Both focusing and button operations can be performed by the holding hand, without requiring the involvement of the other hand.

### BRIEF DESCRIPTION OF THE DRAWING

To more clearly illustrate solutions in embodiments of the present application or in the conventional technology, drawings required in description of the embodiments or the conventional technology will be briefly introduced hereinafter. Apparently, the drawings in the following description only relate to some examples of the present application, and other drawings may be obtained for those skilled in the art based on the drawings without any creative efforts.

FIG. 1 is an axonometric view showing external appearance of a handheld thermal imager with one-hand focusing according to the present application;

FIG. 2 is a sectional view of a handheld thermal imager with one-hand focusing according to the present application;

FIG. 3 is an exploded view of structures related to a body assembly;

FIG. 4 is a front view of a transmission shaft according to a first embodiment; and

FIG. 5 is a front view of a transmission shaft according to a second embodiment.

### LIST OF REFERENCE NUMERALS IN THE DRAWINGS

1. objective lens assembly; 11. objective lens bracket;
111. avoidance notch; 2. body assembly;
21. focusing mechanism; 211. focusing knob;
212. transmission shaft; 2121. helical groove;
2122. annular groove; 2123. rolling bearing;
2124. sealing ring; 213. focusing seat;
2131. guide pin; 2132. position-limiting plate;
214. transmission strip; 2141. avoidance channel;
2142. avoidance hole; 22. control mechanism;
221. circuit board; 222. button;
223. button cover; 23. core mechanism;
231. core bracket; 2311. side block;
2312. first sliding block; 2313. second sliding block;
2314. mounting boss; 24. main bracket;
241. supporting seat; 2411. guide slot;
242. supporting stud; 25. housing;
3. eyepiece assembly; 31. eyepiece bracket;
32. eyecup; 33. diopter adjustment knob;
4. battery.

### DETAIL DESCRIPTION OF EMBODIMENTS

In order to make those skilled in the art better understand technical solutions of the present application, a handheld thermal imager with one-hand focusing according to the present application will be described in detail hereinafter in conjunction with the drawings and embodiments. It should be noted that directional indications herein (such as upper, lower, left, right, front, rear, top, bottom, etc.) are only used to explain relative positional relationships, movements and the like between various components when the handheld thermal imager is held by a user for observation. For example, the side of the handheld thermal imager facing upward is related to an upper part of the handheld thermal imager when held by the user for observation.

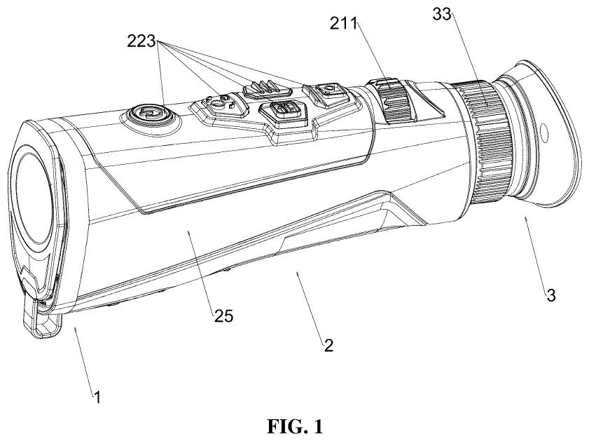

A handheld thermal imager with one-hand focusing is provided according to the present application, which can be held by one hand and allows focusing and button operations to be performed with fingers of the holding hand. Referring to FIGS. 1 to 3, the handheld thermal imager with one-hand focusing includes an objective lens assembly 1, a body assembly 2, an eyepiece assembly 3, and a battery 4. The battery 4 serves as a power supply for the entire thermal imager, and is arranged inside the body assembly 2. The objective lens assembly 1 and the eyepiece assembly 3 are respectively arranged on two sides of the body assembly 2. The objective lens assembly 1 is arranged on one side of the body assembly 2 close to the observed object, and the eyepiece assembly 3 is arranged on one side of the body assembly 2 close to the user. An image signal from the observed object enters through the objective lens assembly 1 and, after undergoing a series of processing, can be observed by the user from the eyepiece assembly 3. The eyepiece assembly 3 includes an eyepiece bracket 31, an eyecup 32, and a diopter adjustment knob 33 rotatable about the optical axis for diopter adjustment. The diopter adjustment knob 33 is configured to adjust the eyepiece bracket 31 to adapt to different visual acuities.

The body assembly 2 is provided with a focusing mechanism 21 for focusing operation and a control mechanism 22 for button-triggered operation. The focusing mechanism 21 includes a focusing knob 211, which is rotatable about a rotating axis parallel to the optical axis, which corresponds to a centerline of light beam. When driven to rotate, the focusing knob 211 drives, via a transmission structure, a core mechanism 23 inside the body assembly 2 or the objective lens assembly 1 to translate in an optical-axis direction, thereby achieving the focusing operation.

The focusing knob 211 is located at one end of the body assembly 2 close to the eyepiece assembly 3. The focusing knob 211 is partially exposed from an upper part, specifically an upper wall of the housing 25 of the body assembly 2. The exposed portion of the focusing knob 211 may be turned by a finger, while the remaining portion of the focusing knob 211 can be embedded inside the housing 25. Specifically, a mounting hole may be formed in the upper wall of the housing 25, and the focusing knob 211 is movably mounted on the housing 25 through the mounting hole. When the handheld thermal imager with one-hand focusing according to the present application is held by the holding hand, the focusing knob 211 is accessible to an index finger of the holding hand. The focusing knob 211 is configured to be turned by the index finger of the holding hand. The focusing knob 211 can rotate clockwise and counterclockwise to drive, via the corresponding transmission structure, the core mechanism 23 inside the housing 25 of the body assembly 2 or the objective lens assembly 1 to translate in the optical-axis direction for focusing. The user can operate the focusing knob 211 with the index finger to perform near and far focusing, facilitating observation of targets at varying distances.

The control mechanism 22 includes buttons 222, for each of which a button cover 223 is arranged on the housing 25 of the body assembly 2. The button cover 223 is made of elastic material, covers the button 222 to provide waterproof and dustproof protection, and has a textured outer surface with raised and recessed patterns to provide tactile indication and feedback. When a finger contacts the button cover 223 and presses the button 222 downward, the button 222 triggers a preset function. The buttons 222 are arranged at an upper part in a middle area of the body assembly 2 in the optical-axis direction, and accessible to an index finger, a middle finger, a ring finger, and a little finger of the holding hand to be pressed by the fingers of the holding hand. The buttons 222 are arranged on the side of the focusing knob 211 close to the objective lens. Specifically, the buttons 222 are positioned in the optical-axis direction between the objective lens assembly 1 and the focusing knob 211, and the buttons 222 as a whole are positioned closer to the focusing knob 211 than to the objective lens assembly 1. During operation, the index finger of the holding hand may operate the focusing knob 211, the thumb provides support by wrapping around the bottom of the handheld thermal imager with one-hand focusing, and the other three fingers are used to press the buttons 222. The focusing knob 211 is turned by the index finger, being the most flexible finger, allowing for maximum operational flexibility. Furthermore, both the focusing knob 211 and the buttons 222 are located on an upper part of the entire handheld thermal imager with one-hand focusing and may be slightly offset to one side. When the handheld thermal imager with one-hand focusing is held by the entire holding hand, a fingertip of the index finger may press on the focusing knob 211, and the middle finger, the ring finger, and the little finger can press on the buttons, perfectly matching the natural hand holding posture. In this way, it is not only possible to achieve one-hand holding, but also to allow for both focusing rotation and button operation by the holding hand. Both focusing and button operations can be performed by the holding hand, without requiring the involvement of the other hand, facilitating user use.

The buttons 222 are arranged in at least one row in the optical-axis direction, with at least one button 222 provided in each row in a direction perpendicular to the optical-axis direction. The buttons 222 may be arranged in one, two, three, or four rows in the optical-axis direction, with one or two buttons 222 provided in each row in the direction perpendicular to the optical-axis direction. Referring to FIG. 1, the buttons 222 are arranged in four rows: three rows each including one button 222, and one row including two buttons 222. Except for a power supply button, there are four buttons 222 arranged in a rhombus pattern, which reduces the total length of the buttons in the optical-axis direction, facilitating finger operation. In the structure shown in FIG. 1, the four buttons 222 are distributed at four vertexes of the rhombus, which reduces the length in the optical-axis direction and results in a more compact arrangement compared with a linear arrangement of the buttons.

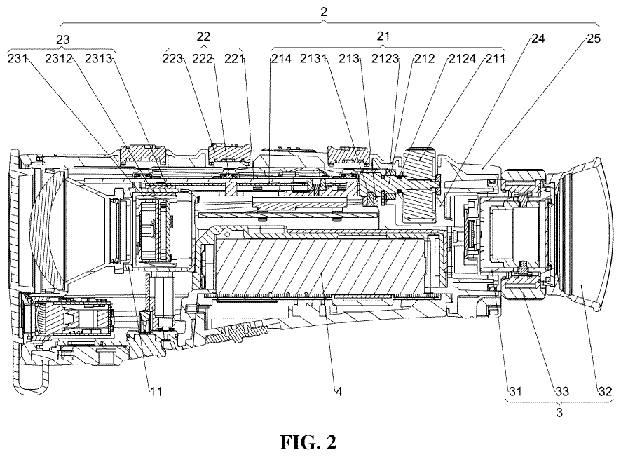

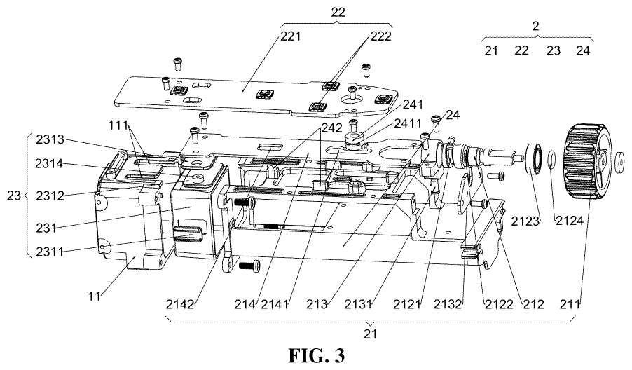

Referring to FIG. 3, the control mechanism according to the present application includes a circuit board 221 on which the buttons 222 are arranged. The circuit board 221 is provided with a printed circuit for transmitting pressing signals. The circuit board 221 is fixed inside the housing 25. Referring to FIG. 2, the circuit board 221 is located above the focusing mechanism 21 and does not interfere with adjustment of various structures of the focusing mechanism 21.

Referring to FIGS. 2 and 3, the focusing mechanism 21 further includes a transmission shaft 212, a focusing seat 213, and a transmission strip 214 connected between the focusing seat 213 and the core mechanism 23. A main bracket is provided inside the housing 25. The focusing knob 211 is connected to the transmission shaft 212 in such a manner that they are fixed relative to each other in a circumferential direction, so as to rotate synchronously with the transmission shaft 212 in the circumferential direction about a rotational axis parallel to the optical axis. The focusing seat 213 is mounted on the main bracket 24 and slidable in the optical-axis direction. The transmission shaft 212 is rotated to drive the focusing seat 213 to translate relative to the main bracket 24. The transmission strip 214 is fixedly connected to both the focusing seat 213 and the core mechanism 23. The core mechanism 23 is driven by the focusing seat 213 to translate via the transmission strip 214. In other words, the focusing seat 213 is movably connected at one end to the transmission shaft 212, and is fixedly connected at the other end to the core mechanism 23. The transmission shaft 212 is configured to, when rotated by the focusing knob 211, drive the focusing seat 213 and thus the core mechanism 23 to translate in the optical-axis direction. The focusing seat 213, the transmission strip 214, and the core mechanism 23 translate synchronously, to change a separation distance between a core and the objective lens, thereby achieving focusing.

Specifically, referring to FIG. 3, a helical groove 2121 is formed in a sidewall of the transmission shaft 212. The helical groove 2121 is a spiral-shaped recess encircling the sidewall of the transmission shaft 212. The focusing seat 213 is provided with a guide pin 2131 fixed thereon. The guide pin 2131 synchronously shifts with the focusing seat 213, meaning that the guide pin 2131 translates in the optical-axis direction along with the focusing seat 213. The guide pin 2131 is slidably inserted into the helical groove 2121 to move helically relative to the helical groove 2121. When the transmission shaft 212 rotates, the guide pin 2131 is subjected to thrust from the helical groove 2121 so as to drive the focusing seat 213 to move linearly. The focusing seat 213 may move linearly in opposite directions depending on a rotation direction of the transmission shaft 212, so as to bring the core closer to or further away from the objective lens.

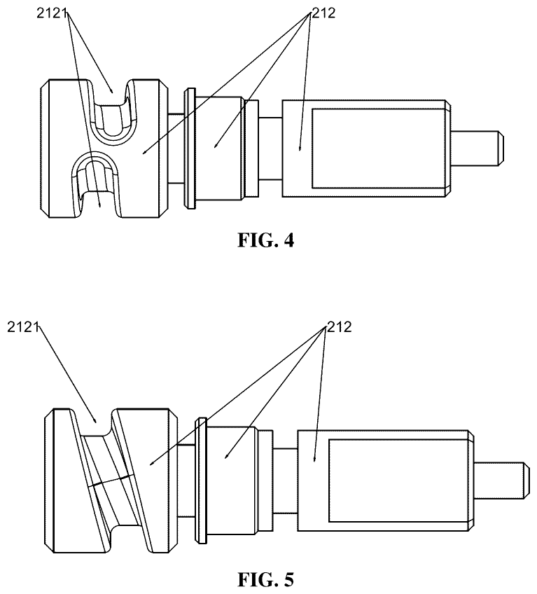

Referring to FIGS. 4 and 5, two configurations of the transmission shaft 212 are provided according to the present application, in which the helical groove 2121 is configured as either a non-enclosed groove with unconnected ends or an enclosed groove with connected ends. FIG. 4 illustrates the helical groove 2121 configured as a non-enclosed groove with unconnected ends. Opposite ends of the helical groove 2121 do not coincide, resembling a single helical line. Upon reaching one end of the helical groove 2121, the guide pin 2131 cannot continue advancing, at which point the transmission shaft 212 may only be rotated in reverse to move the focusing seat 213 in an opposite direction. FIG. 5 illustrates the helical groove 2121 configured as an enclosed groove with connected ends, resembling two joined helical lines. The entire groove forms a loop, which allows continuous rotation of the transmission shaft 212 in one direction, with each full rotation completing two focusing strokes. The entire helical groove 2121 is axisymmetric, with its symmetry plane coinciding with an axis of the transmission shaft 212. The symmetry plane is the paper plane of FIG. 5, with an obscured part at the back side being axisymmetric with a visible part at the front side. When starting from a farthest point from the objective lens, the guide pin 2131 will reach a nearest point to the objective lens by rotating the transmission shaft 212 forward or backwards by 180°. When starting from the nearest point to the objective lens, the guide pin 2131 will reach the farthest point from the objective lens by rotating the transmission shaft 212 forward or backwards by 180°. Utilizing the enclosed groove with connected ends as shown in FIG. 5, the rotation of the transmission shaft 212 in one direction may drive a cyclic focusing: near→far→near→far . . . This provides multiple options for users during focusing: rotating the transmission shaft 212 in each of forward and reverse directions, or continuously rotating it in one direction.

Referring to FIG. 3, the transmission strip 214 according to the present application is flat, plate-like elongated structure. The transmission strip 214 is formed with an avoidance channel 2141, and at least part of an edge of the avoidance channel 2141 is slidably inserted into a guide slot 2411. The avoidance channel 2141 has a larger width at one end to accommodate a supporting seat 241 passing through, and a smaller width at remaining portions, which is less than the width of the supporting seat 241. The supporting seat 241 is arranged on the main bracket 24, and the guide slot 2411 is formed in a sidewall of the supporting seat 241. The guide slot 2411 has a vertical height slightly larger than the thickness of the transmission strip 214 to allow the insertion of the edge of the guide slot 2411, such that the transmission strip 214 can slide along the guide slot 2411 in a translational manner. The guide slot 2411 restricts the transmission strip 214 from rotating, thereby ensuring linear translational movement of the transmission strip 214. The guide slot 2411 serves as a rail for the linear translation of the transmission strip 214.

Referring to FIG. 3, a core bracket 231 of the core mechanism 23 and an objective lens bracket 11 of the objective lens assembly 1 according to the present application each are a rectangular frame, having left and right sidewalls, a top wall, and a bottom wall. Due to a rectangular frame structure, the core bracket 231 and the objective lens bracket 11 can only translate relative to each other in the optical-axis direction and cannot rotate relative to each other. That is, the core bracket 231 is configured to translate relative to the objective lens bracket 11 in the optical-axis direction, and is fixed relative to the objective lens bracket 11 in the circumferential direction.

A side block 2311 is arranged between the sidewall of the core bracket 231 and the corresponding sidewall of the objective lens bracket 11. The side block 2311 may be made of nylon material. The side block 2311 creates a spacer between each sidewall of the core bracket 231 and the corresponding sidewall of the objective lens bracket 11, and provides lubrication to prevent wear caused by direct contact between the sidewalls of the core bracket 231 and the objective lens bracket 11.

A first sliding block 2312 is arranged between a top wall of the core bracket 231 and a top wall of the objective lens bracket 11, and a second sliding block 2313 is arranged between the top wall of the objective lens bracket 11 and the transmission strip 214. The first sliding block 2312 and the second sliding block 2313 can be made of nylon material. The first sliding block 2312 functions as a spacer between the top wall of the core bracket 231 and the top wall of the objective lens bracket 11 to prevent direct contact therebetween, and provides lubrication therebetween. The second sliding block 2313 is arranged between the top wall of the objective lens bracket 11 and the transmission strip 214, providing spacing and lubrication therebetween. Through the spacing and lubrication functions provided by the left and right side blocks 2311, the first sliding block 2312, and the second sliding block 2313, the core bracket 231 moves smoothly in the optical-axis direction.

Referring to FIG. 3, the core bracket 231, the first sliding block 2312, the second sliding block 2313, and the transmission strip 214 are fixedly connected together. Specifically, the core bracket 231, the first sliding block 2312, the second sliding block 2313, and the transmission strip 214 are bolted together, forming an integrated assembly. The top wall of the objective lens bracket 11 is sandwiched between the first sliding block 2312 and the second sliding block 2313.

Referring to FIG. 3, a mounting boss 2314 extends from the top wall of the core bracket 231, and has cylindrical structure. The mounting boss 2314 is screwed with a screw to secure the first sliding block 2312, the second sliding block 2313, and the transmission strip 214. The mounting boss 2314 passes through both the first sliding block 2312 and the second sliding block 2313, with its top end supporting the transmission strip 214. A bolt pass through a through-hole formed in the transmission strip 214 and is screwed into the mounting boss 2314 to achieve secure assembly.

An avoidance notch 111 is formed in the top wall of the objective lens bracket 11 to avoid the mounting boss 2314. As shown in FIG. 3, two mounting bosses 2314 are provided, with each mounting boss corresponding to one avoidance notch 111. The avoidance notch 111 has a width greater than that of the mounting boss 2314, allowing the mounting boss 2314 to move within the avoidance notch 111 to avoid interfering with the movement of the core bracket 231.

A supporting stud 242 extends upward from an upper part of the main bracket 24 to support the circuit board 221. The supporting stud 242 extending upward contacts a lower surface of the circuit board 221. The edge of the transmission strip 214 may contact the supporting stud 242 to guide the translation of the transmission strip 214. An avoidance hole 2142 is formed in the transmission strip 214 to avoid the supporting stud 242. There is at least one supporting stud 242 passing through a corresponding avoidance hole 2142. The avoidance hole 2142 has a length greater than that of the supporting stud 242 in the optical-axis direction, to provide certain guidance for the transmission strip 214 through their mutual engagement.

Referring to FIG. 3, a position-limiting plate 2132 is arranged on the main bracket 24. The position-limiting plate 2132 is fixed at its bottom to the main bracket 24, and is formed at its top with an arc-shaped notch. The position-limiting plate 2132 is configured to engage with an annular groove 2122 formed in the transmission shaft 212. The annular groove 2122 has a width slightly greater than the thickness of the position-limiting plate 2132, thereby restricting the transmission shaft 212 from moving axially and allowing it to rotate only. A rolling bearing 2123 and a sealing ring 2124 may be arranged between the transmission shaft 212 and the main bracket 24. The rolling bearing 2123 improves smoothness of operation, and the sealing ring 2124 may enhance dustproof and waterproof performance.

A one-handed focusing device is also provided according to the present application, which includes a main bracket 24, an objective lens bracket 11, a core bracket 231, a transmission strip 214, a motion conversion assembly, and a focusing knob 211. The main bracket 24 serves as a primary supporting structure and is mounted on a housing 25 of a handheld apparatus. The main bracket 24 is fixed, acting as a reference.

The objective lens bracket 11 or the core bracket 231 can translate relative to the main bracket 24 in an optical-axis direction. That is, one of the objective lens bracket 11 and the core bracket 231 is fixed to the main bracket 24, and the other can translate relative to the main bracket 24. A translation direction of the objective lens bracket 11 or the core bracket 231 aligns with the optical-axis direction of the main bracket 24, where the optical axis corresponds to the centerline of light beam. An objective lens is fixedly mounted on the objective lens bracket 11, and a core is fixedly mounted on the core bracket 231. Light entering through the objective lens passes into the core for respective processing. By adjusting a separation distance between the objective lens bracket 11 and the core bracket 231 in the optical-axis direction, a focusing operation is performed to concentrate the light entering through the objective lens onto an imaging plane of the core, thereby forming a clear image.

The focusing knob 211 is partially exposed to be turned by a finger. The focusing knob 211 is arranged close to an eyepiece end, which is the side where the user' eye observes the image. When held by one hand of the user, the entire apparatus is enveloped and gripped by the palm of the hand. As the user supports the apparatus with the holding hand, the focusing knob 211 is positioned directly opposite an index finger of the holding hand for turning with this finger. That is, the focusing knob 211 is driven by the index finger of the holding hand to rotate clockwise or counterclockwise. By positioning the focusing knob 211 directly opposite the index finger, being the most flexible finger of the entire hand, the focusing knob 211 can be turned with a single finger while the entire apparatus is stably held, so as to perform the focusing operation.

The motion conversion assembly is arranged between the focusing knob 211 and the transmission strip 214, and is configured to convert rotation of the focusing knob 211 into linear translation of the transmission strip 214. The motion conversion assembly serves the function of motion conversion. The transmission strip 214 can only translate linearly, while the focusing knob 211 can only rotate about its rotation axis. The motion conversion assembly unidirectionally converts the rotation of the focusing knob 211 into linear motion of the transmission strip 214.

The transmission strip 214 extends in a direction parallel to the optical axis. The transmission strip 214 is connected at one end to the motion conversion assembly, and is connected at the other end to the objective lens bracket 11 or the core bracket 231, so as to drive the objective lens bracket 11 or the core bracket 231 to translate along the optical axis. One of the objective lens bracket 11 and the core bracket 231 remains fixed relative to the main bracket 24, while the other can translate in a direction parallel to the optical axis. When relative translation occurs between the objective lens bracket 11 and the core bracket 231, a separation distance between the objective lens and the core can be adjusted, thereby achieving focusing. The transmission strip 214, as an intermediate transmission structure, extends at one end to the focusing seat 213 close to the eyepiece and extends at the other end to the objective lens bracket 11 or the core bracket 231. The transmission strip 214 extends across a middle portion of the entire apparatus and exhibits sufficient rigidity to meet transmission requirements. The transmission strip 214 has an elongated or flat structure, occupying minimal internal space within the apparatus.

The one-handed focusing device according to the present application may be applied to an imaging apparatus. The focusing knob 211 for finger operation is located close to the eyepiece. When the entire apparatus is held and supported by the holding hand, the focusing knob 211 is accessible to the index finger of the holding hand, allowing operation with a single finger of the holding hand to achieve both one-handed holding and the focusing. Generally, the index finger is positioned directly opposite the focusing knob 211. When the focusing knob 211 is located close to the index finger, the user can operate the focusing knob 211 with the index finger to perform near and far focusing, facilitating observation of targets at varying distances. The focusing operation can be completed with only one hand during the focusing without the participation of the other hand, which improves convenience of use.

In some embodiments of the present application, the motion conversion assembly includes the transmission shaft 212 and the focusing seat 213 as described above. A translation direction of the focusing seat 213 is parallel to the optical-axis direction.

A helical groove 2121 is formed in a sidewall of the transmission shaft 212. At least part of the helical groove 2121 resembles a helical line. The focusing seat 213 is provided with a guide pin 2131. The guide pin 2131 is engaged with the helical groove 2121. During operation, the guide pin 2131 is inserted into the helical groove 2121 to drive the focusing seat 213 to translate along the optical axis as the transmission shaft 212 rotates. The guide pin 2131 linearly translates synchronously with the focusing seat 213, while moving relative to the helical groove 2121. When the transmission shaft 212 drives the helical groove 2121 to rotate, the helical groove 2121 drives the focusing seat 213 to translate via the guide pin 2131. By rotating the transmission shaft 212 clockwise or counterclockwise, the focusing seat 213 can be reciprocally translated in both directions parallel to the optical axis.

In a particular configuration according to the present application, the objective lens bracket 11 is fixed to one end of the main bracket 24. Referring to FIG. 3, the objective lens bracket 11 is fixed to a left end of the main bracket 24. Particularly, the objective lens bracket 11 may be fixed to the left end of the main bracket 24 by screws. In a direction perpendicular to the optical axis, the core bracket 231 has a cross-sectional area smaller than that of the objective lens bracket 11. The core bracket 231 is slidably mounted inside the objective lens bracket 11 and is constrained by the objective lens bracket 11 to linearly translate. Since the objective lens bracket 11 is fixed relative to the main bracket 24, the objective lens bracket 11 remains fixed, and only the core bracket 231 is adjusted to drive the core to translate along the optical axis.

Referring to FIG. 3, the side block 2311 described above is arranged on each of two side walls of the core bracket 231.

The first sliding block 2312 described above is arranged between the top wall of the core bracket 231 and the top wall of the objective lens bracket 11, and the second sliding block 2313 described above is arranged between the top wall of the objective lens bracket 11 and the transmission strip 214.

A mounting boss 2314 is formed on and extends upward from the top wall of the core bracket 231. Referring to FIG. 3, two mounting bosses 2314 are formed to provide rotational resistance. The first sliding block 2312 and the second sliding block 2313 each are formed with an avoidance hole for avoiding the mounting boss 2314. The mounting boss 2314 passes through the first sliding block 2312 and the second sliding block 2313 in sequence, with its top end supporting the transmission strip 214, and is configured to secure the transmission strip 214, the second sliding block 2313, and the first sliding block 2312 via a screw passing through a through-hole formed in the transmission strip 214 and downward screwed into the mounting boss 2314. The transmission strip 214, the second sliding block 2313, and the first sliding block 2312 are fixedly assembled together when the screw is tightened.

An avoidance notch 111 for avoiding the mounting boss 2314 is formed in the top wall of the objective lens bracket 11. The mounting boss 2314 may pass through the avoidance notch 111 to allow the core bracket 231 to translate relative to the objective lens bracket 11 along the optical axis.

Referring to FIG. 3, the transmission strip 214 according to the present application is a flat plate arranged above the main bracket 24 and exhibits sufficient rigidity to withstand tensile and compressive forces in the optical-axis direction. Alternatively, the transmission strip 214 may has a grid structure or a mesh structure, both of which can synchronously achieve transmission function.

Referring to FIG. 3, a supporting seat 241 is fixedly mounted on the main bracket 24. The supporting seat 241 extends upward, with its top end positioned higher than the transmission strip 214. The supporting seat 241 passes through an avoidance channel 2141 formed in the transmission strip 214. A guide slot 2411 is formed in the supporting seat 241 on each of left and right sides of the supporting seat 241. At least part of an edge of the avoidance channel 2141 formed on the transmission strip 214 can slidingly engage with the guide slot 2411. The engagement between the guide slot 2411 and the avoidance channel 2141 provides linear guidance for the transmission strip 214, preventing the transmission strip 214 from rotating. The avoidance channel 2141 has a larger width at one end to accommodate the supporting seat 241 passing through, and maintains a uniform smaller width at other portions, ensuring that the edge of the avoidance channel 2141 can be slidingly inserted into the guide slot 2411.

Referring to FIG. 3, a position-limiting plate 2132 is fixedly arranged on the main bracket 24. The position-limiting plate 2132 is configured to engage with an annular groove 2122 formed in the transmission shaft 212. The annular groove 2122 is formed encircling a side wall of the transmission shaft 212. The position-limiting plate 2132 is formed with an arc-shaped notch at its top. The annular groove 2122 has a width slightly greater than the thickness of the position-limiting plate 2132, thereby restricting the transmission shaft 212 to only rotate and preventing it from moving forward or backward in the optical-axis direction. When the transmission shaft 212 rotates and helical movement is converted into horizontal movement of the focusing seat 213, the transmission shaft 212 is restricted by a position-limiting block from moving horizontally, and only the focusing seat 213 moves forward and backward.

A handheld thermal imager is further provided according to the present application. Referring to FIGS. 1 and 2, the handheld thermal imager includes the one-handed focusing device described above to achieve thermal imaging by means of the core. The handheld thermal imager further includes a circuit board 221. The circuit board 221 is a PCB board on which corresponding electrical components are arranged. A button 222 for operation is arranged on the circuit board 221 and is covered with a button cover 223, specifically a protective rubber sheath. the button cover 223 has a textured surface with raised and recessed patterns to provide tactile feedback when pressed by the hand. When the button cover 223 is pressed, its corresponding button 222 can be activated. Different buttons 222 trigger corresponding functions when activated.

Several supporting studs 242 are arranged on the main bracket 24. The supporting stud 242 has protruding boss structure in which the supporting stud 242 engages and guides an edge of the transmission strip 214. The supporting stud 242, without interfering with translational movement of the transmission strip 214, limits the transmission strip 214 on both sides in its movement direction, such that the transmission strip 214 performs linear reciprocating movement. A top end of the supporting stud 242 supports the circuit board 221, specifically, a lower surface of the circuit board 221, to provide support for the circuit board 221. The supporting stud 242 supports the circuit board 221, and a threaded hole is formed at a position where the circuit board 221 needs to be fixed, enabling the circuit board 221 to be fixed to the supporting stud 242 via a screw.

With the above description of the disclosed embodiments, those skilled in the art can implement or practice the present application. Various modifications made to these embodiments are apparent to those skilled in the art. The general principle defined herein may be implemented in other embodiments without departing from the spirit or scope of the present application. Therefore, the present application is not limited to the embodiments described herein, but should be in accordance with the broadest scope consistent with the principle and novel features disclosed herein.

1. A handheld thermal imager, comprising:
an objective lens assembly, a body assembly, and an eyepiece assembly that are arranged in sequence,
wherein the body assembly is provided with a focusing mechanism and a control mechanism, the focusing mechanism comprises a focusing knob located at one end of the body assembly close to the eyepiece assembly, and the focusing knob is partially exposed from an upper wall of a housing of the body assembly to be turned by a holding hand for focusing; and
the control mechanism comprises buttons arranged on the upper wall of the housing to be pressed by fingers of the holding hand.

2. The handheld thermal imager according to claim 1, wherein the buttons are arranged in at least one row in an optical-axis direction, with at least one button provided in each row in a direction perpendicular to the optical-axis direction.

3. The handheld thermal imager according to claim 2, wherein there are at least four buttons distributed at four vertexes of a rhombus.

4. The handheld thermal imager according to claim 1, wherein the control mechanism further comprises a circuit board on which the buttons are arranged, and the circuit board is fixed inside the housing.

5. The handheld thermal imager according to claim 4, wherein the focusing mechanism further comprises a transmission shaft and a focusing seat, the focusing knob is connected to the transmission shaft in such a manner that they are fixed relative to each other in a circumferential direction, the focusing seat is movably connected at one end to the transmission shaft, and is fixedly connected at the other end to a core mechanism inside the housing, and the transmission shaft is configured to, when rotated by the focusing knob, drive the focusing seat and thus the core mechanism to translate in the optical-axis direction.

6. The handheld thermal imager according to claim 5, wherein a helical groove is formed in a sidewall of the transmission shaft, and the focusing seat is provided with a guide pin which is slidably inserted into the helical groove to move helically relative to the helical groove.

7. The handheld thermal imager according to claim 6, wherein the helical groove is configured as a non-enclosed groove with unconnected ends, or an enclosed groove with connected ends.

8. The handheld thermal imager according to claim 5, wherein a main bracket is arranged inside the housing, the focusing mechanism further comprises a transmission strip connected between the focusing seat and the core mechanism, a supporting seat is arranged on the main bracket, and a guide slot is formed in a sidewall of the supporting seat; and
an avoidance channel is formed in the transmission strip, and at least part of an edge of the avoidance channel is slidably inserted into the guide slot.

9. The handheld thermal imager according to claim 8, wherein a core bracket of the core mechanism is configured to translate relative to an objective lens bracket of the objective lens assembly in the optical-axis direction, and is fixed relative to the objective lens bracket of the objective lens assembly in a circumferential direction;
a side block is arranged between a sidewall of the core bracket and a corresponding sidewall of the objective lens bracket; and
a first sliding block is arranged between a top wall of the core bracket and a top wall of the objective lens bracket, and a second sliding block is arranged between the top wall of the objective lens bracket and the transmission strip.

10. The handheld thermal imager according to claim 9, wherein a mounting boss is extends from the top wall of the core bracket to be screwed with a screw so as to secure the first sliding block, the second sliding block, and the transmission strip; and
an avoidance notch is formed in the top wall of the objective lens bracket to avoid the mounting boss.

11. The handheld thermal imager according to claim 8, wherein a supporting stud extends upward from an upper part of the main bracket to support the circuit board; and
an avoidance hole is formed in the transmission strip to avoid the supporting stud.

12. The handheld thermal imager according to claim 8, wherein a position-limiting plate is arranged on the main bracket to engage with an annular groove formed in the transmission shaft.

13. The handheld thermal imager according to claim 1, wherein the eyepiece assembly comprises a diopter adjustment knob, which is rotatable about an optical axis for diopter adjustment.

14. The handheld thermal imager according to claim 1, wherein the focusing knob is configured to rotate about a rotating axis parallel to an optical axis.

15. The handheld thermal imager according to claim 1, wherein the focusing knob is positioned to such that, when the handheld thermal imager is held by a user for operation, the focusing knob is accessible to an index finger of the holding hand, and the buttons are accessible to a middle finger, a ring finger, and a little finger of the holding hand, respectively.

16. The handheld thermal imager according to claim 1, wherein the buttons are positioned in an optical-axis direction between the objective lens assembly and the focusing knob, and the buttons as a whole are positioned closer to the focusing knob than to the objective lens assembly.

17. The handheld thermal imager according to claim 4, wherein the circuit board is fixed inside the housing, and the circuit board is provided with a printed circuit for transmitting pressing signals.

18. The handheld thermal imager according to claim 8, wherein the focusing seat is mounted on the main bracket and slidable in the optical-axis direction.

19. The handheld thermal imager according to claim 9, wherein the core bracket of the core mechanism and the objective lens bracket of the objective lens assembly each are a rectangular frame.

20. The handheld thermal imager according to claim 9, wherein the core bracket, the first sliding block, the second sliding block, and the transmission strip are fixedly connected together.
